(19) United States
(12) Patent Application Publication
(10) Pub. No.: US 2014/0151258 A1
(43) Pub. Date: Jun. 5, 2014

(54) Polymeric Films Comprising Biodegradable Polyester or Copolymer Thereof

(71) Applicant: CRYOVAC, INC., Duncan, SC (US)

(72) Inventors: Parimal M. Vadhar, Greer, SC (US); Larry B. McAllister, JR., Spartanburg, SC (US); XiaoJun Li, Shanghai (CH)

(73) Assignee: Cryovac, Inc., Duncan, SC (US)

(21) Appl. No.: 13/692,213

(22) Filed: Dec. 3, 2012

(51) Int. Cl. C08L 67/00; B65D 65/38; B65D 23/08; B65C 3/06

(52) U.S. Cl. CPC C08L 67/00; B65C 3/065; B65D 65/38; B65D 23/0878
USPC 206/497; 428/34.9; 53/441; 53/442; 525/418

(57) ABSTRACT

The presently disclosed subject matter is directed to a film comprising a blend of about 90% to 99% polyester and about 1% to 10% biodegradable aliphatic or aromatic polyester (by weight). It has been surprisingly discovered that polymeric films comprising the disclosed blend exhibit improved flexibility and impact strength compared to polyester films known in the art. Films with the disclosed blends also advantageously do not adversely affect recyclability of the film. The disclosed films can be used in a wide variety of areas, including (but not limited to) shrink sleeve applications.

### FIELD OF THE INVENTION

The presently disclosed subject matter relates generally to polymeric films comprising a least one layer incorporating a blend of polyester and biodegradable aliphatic or aromatic polyester, and methods of making and using the same.

### BACKGROUND

Polyesters and polyester copolymers are well known thermoplastic polymers, and are useful for the manufacture of a wide variety of articles, from fibers to packaging. Polyesters have a number of advantageous properties, such as good resilience, low creep, resistance to impact, flex-fatigue resistance, and resistance to fuels, oils, and other organic solvents. Because of these properties, polyester can be used in a wide variety of applications, such as the manufacture of films, food and beverage containers, and the like.

Impact resistance is an important characteristic of a polymeric film. Specifically, impact strength is a qualitative measure of the ability of a material to withstand shock loading in a standard test. The benefits of increased impact resistance include the reduction of damage to films during manufacturing, shipping, handling, and the like. Such benefits can specifically include less frequent package leakage, improved wear resistance, and improved protection of the packaged product.

In addition, it is advantageous that polymeric films be flexible to enable them to be used in a wide variety of applications. Particularly, one advantage of a flexible film is that is can be easily formed into an assortment of shapes or configurations. To this end, a flexible film can easily package a wide variety of articles in a range of shapes and sizes.

Therefore, it would be beneficial to provide a film comprising a blend that incorporates the beneficial properties of polyester mentioned above, with the addition of superior flexibility and impact strength characteristics. It would also be beneficial if the disclosed blend did not adversely affect the recyclable quality of the film.

### SUMMARY

In some embodiments, the presently disclosed subject matter is directed to a polymeric film comprising at least one layer comprising a blend of a first component and a second component. The first component comprises about 90 to 99% polyester, based on the total weight of the layer. The second component comprises about 1 to 10% biodegradable aliphatic and/or aromatic polyester, based on the total weight of the layer. The film has a free shrink at 185° F. in at least one of the machine or transverse directions of at least about 10% measured in accordance with ASTM D 2732.

In some embodiments, the presently disclosed subject matter is directed to a packaged object comprising a container comprising a polymeric film and defining an interior space. The packaged object comprises an object enclosed in the interior space of the container, wherein the film has been shrunk to the container. The polymeric film comprises at least one layer comprising a blend of a first component and a second component. The first component comprises about 90 to 99% polyester, based on the total weight of the layer. The second component comprises about 1 to 10% biodegradable aliphatic and/or aromatic polyester, based on the total weight of the layer. The film has a free shrink at 185° F. in at least one of the machine or transverse directions of at least about 10% measured in accordance with ASTM D 2732.

In some embodiments, the presently disclosed subject matter is directed to a method of labeling a container. The method comprises obtaining a film comprising at least one layer comprising first and second components. The first component comprises about 90 to 99% polyester, based on the total weight of the layer. The second component comprises about 1 to 10% biodegradable aliphatic and/or aromatic polyester, based on the total weight of the layer. The method further comprises forming the film into a shrink sleeve, positioning the shrink sleeve over the container, and shrinking the sleeve to the container.

In some embodiments, the presently disclosed subject matter is directed to a method of making a package. Particularly, the method comprises obtaining a film comprising at least one layer comprising first and second components. The first component comprises about 90 to 99% polyester, based on the total weight of the layer. The second component comprises about 1 to 10% biodegradable aliphatic and/or aromatic polyester, based on the total weight of the layer. The method further comprises obtaining a container, forming the film into a shrink sleeve, positioning the shrink sleeve around the container, and shrinking the sleeve to the container.

### BRIEF DESCRIPTION OF THE DRAWINGS

FIG. 1 is a perspective view of an article surrounded by a shrink sleeve in accordance with some embodiments of the presently disclosed subject matter.

FIG. 2 is a perspective view of the article of FIG. 1 after the shrink sleeve has been conformed to the shape of the article.

### DETAILED DESCRIPTION

### I. General Considerations

The presently disclosed subject matter is directed to a film comprising a layer that includes a blend of a first component and a second component. Particularly, the first component comprises about 90% to 99% polyester, based on the total weight of the layer. The second component comprises about 1% to 10% biodegradable aliphatic and/or aromatic polyester, based on the total weight of the layer. It has been surprisingly discovered that polymeric films comprising the disclosed blend exhibit improved flexibility and impact strength compared to polyester films known in the art. Films with the disclosed blends also advantageously do not adversely affect recyclability of the film. The disclosed films can be used in a wide variety of areas, including (but not limited to) shrink sleeve applications.

### II. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a film” includes a plurality of such films, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, from the specified amount, as such variations are appropriated in the disclosed films and methods.

As used herein, the term “abuse layer” refers to an outer film layer and/or an inner film layer, so long as the film layer serves to resist abrasion, puncture, and other potential causes of reduction of package integrity, as well as potential causes of reduction of package appearance quality. The abuse layer can comprise any polymer, so long as the polymer contributes to achieving an integrity goal and/or an appearance goal. In some embodiments, the abuse layer can comprise polyamide, ethylene/propylene copolymer (such as, but not limited to, nylon 6, nylon 6/6, amorphous nylon), and/or combinations thereof. In some embodiments, the abuse layer can comprise polymer having a modulus of at least 10⁷ Pascals at room temperature.

As used herein, the term “aliphatic polyester” refers to any polyester made from aliphatic monomers (e.g., adipic acid and the like). Thus, the term “aliphatic polyester” can refer to a polyester comprising residues from aliphatic dicarboxylic acids, cycloaliphatic dicarboxylic acids, aliphatic diols, cycloaliphatic dials, or a mixture thereof. In some embodiments, the term “aliphatic” can include both aliphatic and cycloaliphatic structures, such as dials, diacids, and hydroxycarboxylic acids, that contain as a backbone a straight or branched chain or cyclic arrangement of the constituent carbon atoms that can be saturated or paraffinic in nature, unsaturated, i.e., containing non-aromatic carbon-carbon double bonds, or acetylenic, i.e., containing carbon-carbon triple bonds. Thus, the term “aliphatic” can include linear, branched, chain, and cyclic structures.

The term “aromatic polyester” as used herein refers to a polyester made from at least one aromatic monomer.

As used herein, the terms “barrier” and “barrier layer” refer to the ability of a film or film layer to serve as a barrier to gases and/or odors. Examples of polymeric materials with low oxygen transmission rates useful in such a layer can include: ethylene/vinyl alcohol copolymer (EVOH), polyvinylidene dichloride (PVDC), vinylidene chloride copolymer such as vinylidene chloride/methyl acrylate copolymer, vinylidene chloride/vinyl chloride copolymer, polyamide, polyester, polyacrylonitrile (available as Barex™ resin), or blends thereof. Oxygen barrier materials can further comprise high aspect ratio fillers that create a tortuous path for permeation (e.g., nanocomposites). Oxygen barrier properties can be further enhanced by the incorporation of an oxygen scavenger, such as an organic oxygen scavenger. In some embodiments, metal foil, metallized substrates (e.g., metallized polyethylene terephthalate ((PET)), metallized polyamide, and/or metallized polypropylene), and/or coatings comprising SiOx or AlOx compounds can be used to provide low oxygen transmission to a package. In some embodiments, a barrier layer can have a gas (e.g., oxygen) permeability of less than or equal to about 500 cc/m²/24 hrs/atm at 73° F., in some embodiments less than about 100 cc/m²/24 hrs/atm at 73° F., in some embodiments less than about 50 cc/m²/24 hrs/atm at 73° F., and in some embodiments less than about 25 cc/m²/24 hrs/atm at 73° F.

As used herein, the term “biodegradable” refers to a material that degrades from the action of naturally occurring microorganisms, such as (but not limited to) bacteria, fungi, and algae; environmental heat; moisture; and/or other environmental or mechanical factors, such as determined according to ASTM Test Method 5338.92, incorporated in its entirety herein. It should be noted that the content of all ASTM standards referenced in the instant disclosure are hereby incorporated by reference in their entireties.

The term “bulk layer” as used herein refers to a film layer used to increase the abuse-resistance, toughness, modulus, etc., of a film. In some embodiments, the bulk layer can comprise polyolefin (including but not limited to) at least one member selected from the group comprising ethylene/alpha-olefin copolymer, ethylene/alpha-olefin copolymer plastomer, low density polyethylene, and/or linear low density polyethylene and polyethylene vinyl acetate copolymers.

As used herein, the terms “core” and “core layer” refer to any internal layer that can have a function other than serving as an adhesive or compatibilizer for adhering two layers to one another. In some embodiments, the core layer or layers provide a film with the desired level of strength, optics, abuse resistance, and/or specific impermeability.

As used herein, the term “film” can be used in a generic sense to include plastic web, regardless of whether it is film or sheet.

As used herein, the terms “first” and “second” are not intended to be limiting, and are merely included as a means to identify film components.

As used herein, the term “free shrink” refers to the percent dimensional change in a 10 cm×10 cm specimen of film, when subjected to selected heat, as measured by ASTM D 2732.

The term “impact strength” as used herein refers to mechanical strength of a sample relating to resistance to certain impacts thereto, as measured by ASTM D3753.

As used herein, the term “package” refers to packaging materials used in the packaging of a product.

The term “polybutylene succinate” or “PBS” as used herein refers to an aliphatic biodegradable polyester produced from succinic acid and 1,4 butanediol. PBS is available commercially from, for example, Myriant Corporation (Quincy, Mass., United States of America) and Zhejiang Hangzhou Xinfu Pharmaceutical Co. (Zhejiang, China).

The term “polybutylene succinate adipate” or “PBSA” refers to an aliphatic biodegradable polyester produced from butanediol, succinic acid, and adipic acid. Commercial sources of PBSA include, for example, SK Chemicals (Shanghai, China), Showa Highpolmer Company, Ltd. (Tokyo, Japan), and Zhejiang Hangzhou Xinfu Pharmaceutical Co. (Zhejiang, China).

As used herein, the term “polybutylene adipate terephthalate” or “PBAT”, refers to an aromatic biodegradable copolyester produced from polybutylene adipate and polybutylene terephtalate. Commercial sources of PBAT can include BASF AG (Florham Park, N.J., United States of America) and Zhejiang Hangzhou Xinfu Pharmaceutical Co. (Zhejiang, China).

The term “polyhydroxyalkanoate” or “PHA” as used herein refers broadly to renewable, thermoplastic aliphatic polyesters that can be produced by the polymerization of the respective monomer hydroxy aliphatic acids (including dimers of the hydroxy aliphatic acids), by bacterial fermentation of starch, sugars, lipids, and the like. PHA polymers can include (but are not limited to) poly-beta-hydroxybutyrate (PHB), polyhydroxyvalerate (PHV), polyhydroxybutyrate-covalerate (PHBN), and polyhydroxyhexanoate (PHH), poly-alpha-hydroxybutyrate (also known as poly-2-hydroxybutyrate), poly-3-hydroxypropionate, poly-3-hydroxyvalerate, poly-4-hydroxybutyrate, poly-4-hydroxyvalerate, poly-5-hydroxyvalerate, poly-3-hydroxyhexanoate, poly-4-hydroxyhexanoate, poly-6-hydroxyhexanoate, polyhydroxybutyrate-valerate, polyglycolic acid, polylactic acid (PLA), and the like, as well as PHA copolymers, blends, mixtures, combinations, etc., of different PHA polymers, etc. In some embodiments, PHA can be synthesized by methods disclosed in, for example, U.S. Pat. Nos. 7,267,794; 7,276,361; 7,208,535; 7,176,349; and 7,025,908, the entire disclosures of which are hereby incorporated by reference.

The term “polyester” as used herein refers to polymers obtained by the polycondensation reaction of dicarboxylic acids with dihydroxy alcohols or alternatively by the ring-opening polycondensation reaction of lactones or lactides. Thus, the term “polyester” refers to both homo-polyesters and co-polyesters, wherein homo-polyesters are defined as polymers obtained from the condensation of one dicarboxylic acid with one diol and co-polyesters are defined as polymers obtained from the condensation of one or more dicarboxylic acids with one or more dials. Suitable polyester resins can include (but are not limited to) polyesters of ethylene glycol and terephthalic acid (i.e. polyethylene terephthalate or “PET”). The remaining monomer units can be selected from other dicarboxylic acids or diols, including (but not limited to) isophthalic acid, phthalic acid, 2,5-, 2,6- or 2,7-naphthalenedicarboxylic acid. Suitable diols can include aliphatic diols (such as ethylene glycol, diethylene glycol, triethylene glycol, propylene glycol, 1,3-butane diol, 1,4-butane diol, 1,5-pentane diol, 2,2-dimethyl-1,3-propane diol, neopentyl glycol and 1,6-hexane diol), cycloaliphatic dials (such as 1,4-cyclohexanedimethanol and 1,4-cyclohexane diol) or heteroatom-containing diols having one or more rings. Co-polyester resins derived from one or more dicarboxylic acid(s) or their lower alkyl (up to 14 carbon atoms) diesters with one or more glycol(s) can also be used in accordance with the presently disclosed subject matter. Suitable dicarboxylic acids can in some embodiments include aromatic dicarboxylic acids (such as terephthalic acid, isophthalic acid, phthalic acid, or 2,5-, 2,6- or 2,7-naphthalenedicarboxylic acid) and aliphatic dicarboxylic acids (such as succinic acid, sebacic acid, adipic acid, azelaic acid, suberic acid or pimelic acid). Suitable glycol(s) can include aliphatic diols (such as ethylene glycol, diethylene glycol, triethylene glycol, propylene glycol, 1,3-butane diol, 1,4-butane diol, 1,5-pentane diol, 2,2-dimethyl-1,3-propane diol, neopentyl glycol and 1,6-hexane diol) and cycloaliphatic diols (such as 1,4-cyclohexanedimethanol and 1,4-cyclohexane diol). Suitable amorphous co-polyesters are those derived from an aliphatic diol and a cycloaliphatic diol with one or more, dicarboxylic acid(s).

The term “PETG” refers to a polyethylene terephthalate glycol produced from the condensation reaction of ethylene terephthalic acid, cyclohexanedimethanol, and ethylene glycol. PETG is available commercially as, for example, Embrace®, Embrace LV®, and Eastar® 6763 (all available from Eastman Chemical Company, Kingsport, Tenn., United State of America).

The term “polycarbonate” as used herein refers to linear thermoplastic polyesters of carbonic acid with aliphatic, cycloaliphatic, or aromatic dihydroxy compounds.

As used herein, the term “polymer” refers to the product of a polymerization reaction, and can be inclusive of homopolymers, copolymers, terpolymers, etc. In some embodiments, the layers of a film can consist essentially of a single polymer, or can have additional polymer together therewith, i.e., blended therewith.

As used herein, the term “seal” refers to any seal of a first region of an outer film surface to a second region of an outer film surface, including heat or any type of adhesive material, thermal or otherwise. In some embodiments, the seal can be formed by heating the regions to at least their respective seal initiation temperatures. The sealing can be performed by any one or more of a wide variety of means, including (but not limited to) using a heat seal technique (e.g., melt-bead sealing, thermal sealing, impulse sealing, dielectric sealing, radio frequency sealing, ultrasonic sealing, hot air, hot wire, infrared radiation).

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 3 mils of a film can be involved in the sealing of the film to itself or another layer. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

The term “shrink sleeve” as used herein refers to any of a wide variety of polymeric films that are placed on a container and are subsequently heated to shrink onto the external surface of the container and take the shape thereof. Seel, for example, U.S. Pat. Nos. 7,406,811; 5,302,428; 8,114,491; and 2011/0177267, the entire contents of which are hereby incorporated by reference.

As used herein, the term “skin layer” refers to an outside layer of a multilayer film in packaging a product, the skin layer being subject to abuse.

As used herein, the term “tie layer” refers to an internal film layer having the primary purpose of adhering two layers to one another. In some embodiments, tie layers can comprise any nonpolar polymer having a polar group grafted thereon, such that the polymer is capable of covalent bonding to polar polymers such as polyamide and ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

All compositional percentages used herein are presented on a “by weight” basis, unless designated otherwise.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

### III. The Disclosed Film

### III.A. Generally

The presently disclosed film can be multilayer or monolayer. Typically, however, the films employed will have two or more layers to incorporate a variety of properties, such as sealability, gas impermeability, and toughness into a single film. Thus, in some embodiments, the disclosed film comprises a total of from about 1 to about 20 layers; in some embodiments, from about 2 to about 12 layers; and in some embodiments, from about 3 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that the disclosed film can comprise more than 20 layers, such as in embodiments wherein the film components comprise microlayering technology.

The disclosed film can have any total thickness desired, so long as the film provides the desired properties for the particular packaging operation in which the film is used, e.g., optics, modulus, seal strength, and the like. Final web thicknesses can vary, depending on processing, end use application, and the like. Typical thicknesses can range from about 0.1 to 20 mils; in some embodiments, about 0.3 to 15 mils; in some embodiments, about 0.5 to 10 mils; in some embodiments, about 1 to 8 mils; in some embodiments, about 1 to 4 mils; and in some embodiments, about 1 to 2 mils. Thus, in some embodiments, the disclosed film can have a thickness of about 10 mils or less; in some embodiments, a thickness of about 5 mils or less.

In some embodiments, the disclosed film can comprise printed product information such as (but not limited to) product size, type, name of manufacturer, use instructions, and the like. Such printing methods are well known to those of ordinary skill in the packaging art.

### III.B. The Blend Layer

The presently disclosed subject matter comprises a polymeric film with a layer comprising a blend of first and second components. Particularly, the first and second components comprise polyester and biodegradable aliphatic and/or aromatic polyester (such as, for example, polybutylene succinate), respectively. The disclosed blend can be present in any layer of the film. For example, in some embodiments, the blend layer can be the skin layer of the disclosed film. However, in some embodiments, the blend layer can be a sealant layer, core layer, barrier layer, abuse layer, or combinations thereof.

Continuing, the disclosed film includes a layer comprising a first component comprising a blend of about 90 to 99 percent polyester; in some embodiments, about 92 to 99 percent polyester; and in some embodiments, about 95 to 98 percent polyester, based on the total weight of the layer. Further, the disclosed film includes a layer comprising a second component comprising a blend of about 1 to 10 percent biodegradable aliphatic and/or aromatic polyester; in some embodiments, about 1 to 8 percent biodegradable aliphatic and/or aromatic polyester; and in some embodiments, about 2 to 5 percent biodegradable aliphatic and/or aromatic polyester, based on the total weight of the layer. Thus, in some embodiments, the disclosed film includes a layer comprising a blend of about 90, 90.5, 91, 91.5, 92, 92.5, 93, 93.5, 94, 94.5, 95, 95.5, 96, 96.5, 97, 97.5, 98, 98.5, or 99 percent polyester, based on the total weight of the layer. Similarly, the disclosed film can include a layer comprising a blend of about 1, 1.5, 2, 2.5, 3, 3.5, 4, 4.5, 5, 5.5, 6, 6.5, 7, 7.5, 8, 8.5, 9, 9.5, or 10 percent biodegradable aliphatic and/or aromatic polyester, based on the total weight of the layer.

Examples of suitable polymers that can be included as the first component in the disclosed blend layer can include (but are not limited to) polycarbonate (PC), homopolymers and copolymers of alkyl-aromatic esters, such as polyethylene terephthalate (PET), amorphous polyethylene terephthalate (APET), crystalline polyethylene terephthalate (CPET), glycol-modified polyethylene terephthalate (PETG), and polybutylene terephthalate (PBT), and copolymers thereof. However, one of ordinary skill in the art would recognize that any of a wide variety of polymers can be used in accordance with the presently disclosed subject matter. For example, in some embodiments, SPG-PET Altester® (available from Mitsubishi Polyester Films, Inc. (Greer, S.C., United States of America) can be used as the first component in the disclosed blend.

As set forth herein, the disclosed blend layer further comprises a second component comprising at least one biodegradable aliphatic and/or aromatic polyester. Suitable examples can include (but are not limited to) polybutylene succinate (PBS), polybutylene succinate adipate (PBSA), polybutylene adipate butylene terephthalate copolymer (PBAT), polyhydroxyalkanoate (PHA), and copolymers thereof.

Other additives can be included in the blend layer, as would be apparent to those having ordinary skill in the packaging art. For example, suitable additives can include (but are not limited to) stabilizers, UV screening agents, oxidants, antioxidants, pigments/dyes, fillers, and/or the like. Effective additive amounts and processes for inclusion of the additives to polymeric compositions are known to those of ordinary skill in the art.

### III.C. Additional Film Layers

In addition to the disclosed blend layer, the disclosed film can in some embodiments comprise one or more barrier layers, abuse layers, bulk layers, tie layers, and/or sealant layers. The disclosed film can include other additives commonly used in the packaging art, including (but not limited to) plasticizers, thermal stabilizers (e.g., epoxidized soybean oil), lubricating processing aid (e.g., one or more acrylates), processing aids, slip agents, antiblock agents, and pigments. In some embodiments, the amount of additives present in the film is minimized such that the film properties are not deteriorated.

### IV. Methods of Making the Disclosed Film

The disclosed film can be constructed using any suitable process known to those of ordinary skill in the art, including (but not limited to) coextrusion, lamination, extrusion coating, and combinations thereof. See, for example, U.S. Pat. No. 6,769,227 to Mumpower; U.S. Pat. No. 3,741,253 to Brax et al.; U.S. Pat. No. 4,278,738 to Brax et al.; U.S. Pat. No. 4,284,458 to Schirmer; and U.S. Pat. No. 4,551,380 to Schoenberg, each of which is hereby incorporated by reference in its entirety.

Thus, in some embodiments, the disclosed film can be prepared by extrusion or coextrusion utilizing, for example, a tubular trapped bubble film process or a flat film (i.e., cast film or slit die) process. The film can also be prepared by extrusion coating. Alternatively, multilayer embodiments of the present film can be prepared by adhesively laminating or extrusion laminating the various layers. A combination of these processes can also be employed. Such processes are known to those of skill in the art.

Preparation of compositions for each layer used in the disclosed film can be achieved in several different ways. The components can be brought into intimate contact by, for example, dry blending the materials and then passing the overall composition through a compounding extruder. Alternatively, the components can be fed directly to a mixing device such as a compounding extruder, high shear continuous mixer, two roll mill or an internal mixer such as a Banbury mixer. It is also possible to achieve melt mixing in an extruder section of a coextrusion apparatus. Overall, the objective is to obtain a uniform dispersion of all ingredients, which can be achieved by inducing sufficient shear and heat to cause the plastics component(s) to melt. However, the time and temperature of mixing should be controlled as is normally done by one skilled in the art to avoid molecular weight degradation.

In some embodiments, the disclosed film can be oriented in either the machine (i.e., longitudinal), the transverse direction, or in both directions (i.e., biaxially oriented), for example, to enhance the strength, optics, and durability of the film. In some embodiments, a web or tube of the film can be uniaxially or biaxially oriented by imposing a draw force at a temperature where the film is softened (e.g., above the vicat softening point or glass transition temperature; see ASTM 1525 and ASTM D3418) and for example at a temperature below the film's melting point. The film can then be quickly cooled to retain the physical properties generated during orientation and to provide a heat-shrink characteristic to the film. In some embodiments, the film can be oriented using, for example, a tenter-frame process or a bubble process. The orientation can occur in one direction (i.e., the machine or transverse direction) and/or two directions (e.g., the machine and transverse directions) by at least about, and/or at most about, any of the following ratios: 1.5:1, 2:1, 2.5:1, 3:1, 3.5:1, 4:1, 5:1, 6:1, 7:1, 8:1, 9:1, 10:1, 12:1, and 15:1. The film can be stretched by any of these amounts in one direction and another of any of these amounts in another direction.

The disclosed film can have a free shrink at 185° F. in one direction (e.g., the machine direction or the transverse direction) and/or in both the machine and transverse directions of at least about, and/or at most about, any of the following: 10%, 15%, 20%, 25%, 30%, 35%, 40%, 45%, 50%, 55%, 60%, 65%, 70%, or 75%. The free shrink of the disclosed film is determined by measuring the percent dimensional change in a 10 cm×10 cm film specimen when subjected to selected heat (i.e., at a specified temperature exposure) according to ASTM-D 2732. All references to free shrink in this application are measured according to this standard.

In some embodiments, the disclosed film can have a printed image applied to it, for example, by any suitable ink printing method, such as rotary screen, gravure, or flexographic techniques. The printed image can be applied to a skin layer. The printed image can be applied as a reverse printed image, for example, applied to the inside layer of the film of a shrink sleeve.

### V. Methods of Using the Disclosed Film

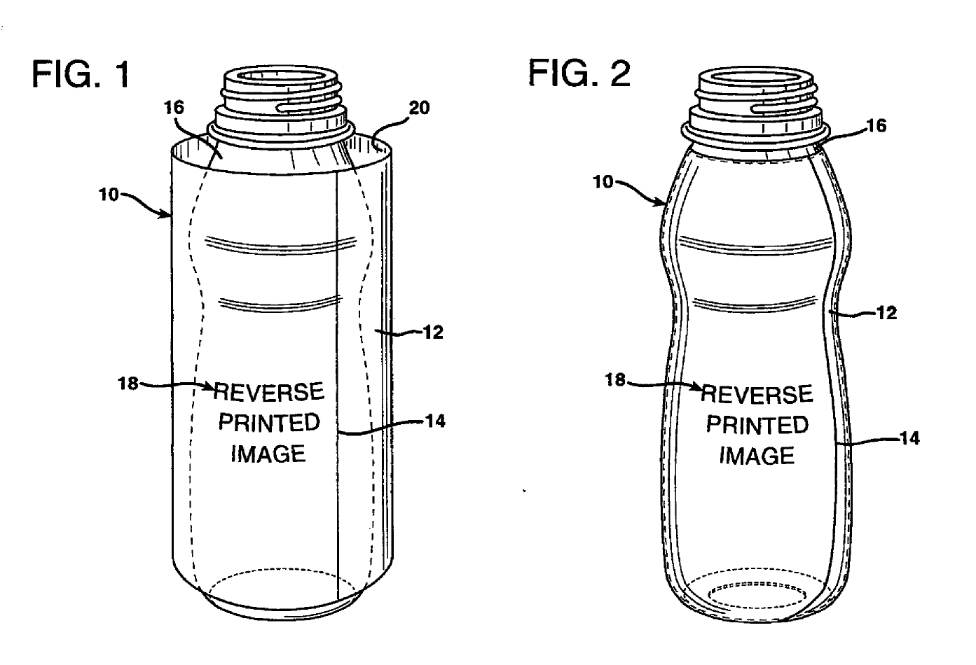

The disclosed film can be converted to an end-use article by any suitable method (e.g., a plastics shaping process). The end-use article can be any of a wide variety of articles, including (but not limited to) films, bottles, containers, cups, lids, plates, trays, fibers, and the like. In some embodiments, the disclosed film can be used in shrink sleeve applications. Particularly, as illustrated in FIG. 1, the article can be shrink sleeve 10 (also known in some embodiments as a shrink sleeve label or a shrink band) comprising film 12. The article can be a seamed shrink sleeve (as illustrated in FIG. 1), a seamless shrink sleeve, or a roll-fed shrink sleeve (i.e., formed by roll-fed shrink film for wraparound labeling).

To this end, a seamed shrink sleeve can be manufactured from a flat configuration of the disclosed film that is seamed by attaching the film to itself to form a tube having seam 14 using, for example, an adhesive. If sleeve 10 is to be printed, the formation of the film into a tube can occur after images have been printed onto the film. In some embodiments, the printed image 18 can be applied as a reverse printed image to the inside surface 20. The tube can then be cut to individual lengths to form the individual seamed shrink sleeves. The shrink sleeve can be placed to surround the item (e.g., container 16) to which the shrink sleeve is to be applied. Heat can then be applied (e.g., by placing the shrink-sleeved item into a heat tunnel using, for example, steam or hot air) so that the heat shrink characteristic of the sleeve is activated and reduced in size to conform to the shape of the item that the shrink sleeve surrounds, as illustrated in FIG. 2.

In some embodiments, a seamless shrink sleeve comprising the disclosed film can be manufactured by extruding the film in a tube configuration. The resulting tube can be printed and cut to desired lengths to form individual shrink sleeves, as is well known in the packaging art.

In some embodiments, a roll-fed shrink sleeve comprising the disclosed film can be manufactured by applying a pick-up adhesive to the leading edge of the film that has been cut into the desired dimensions. The leading edge can then be adhered to a container and positioned such that the film surrounds the container. An adhesive can then be applied to the trailing edge of the film, such that the trailing edge of the film can be adhered to the container or to the leading edge area of the film. The shrink sleeve/container is then exposed to heat to activate the shrink characteristic of the film.

A shrink sleeve comprising the disclosed film can be used in a wide variety of applications, including (but not limited to) as a label applied to an item, as a tamper-evident seal or packaging material (e.g., a tamper-evident neck band), and/or to unitize two or more items (e.g., multi-packing). In some embodiments, the shrink sleeve can be a full-body sleeve for enclosing a container. In some embodiments, the shrink sleeve can be used to enclose a shaped and/or contoured container (e.g., an asymmetrically-shaped container).

It should be noted that although shrink sleeve applications have been described herein, the disclosed film is not limited and can be used in any of a wide variety of packaging applications known in the art.

### VI. Advantages of the Presently Disclosed Subject Matter

The disclosed film exhibits increased flexibility compared to prior art polyester films lacking the disclosed blend. Particularly, in some embodiments, the disclosed film has a flexural modulus of elasticity at room temperature of less than 2 GPa, measured in accordance with ASTM D-790.

It has been observed that the disclosed film exhibits improved impact strength compared to polyester films known in the art. Particularly, the disclosed film has an instrumented impact strength with an average energy to break of at least 2 Joules; in some embodiments, from about 3 to 10 Joules; in some embodiments, from about 4 to 9 Joules; and in some embodiments, from about 5 to 8 Joules, measured in accordance with ASTM D-3753.

It has also been noted that films comprising the disclosed blends do not exhibit an adverse effect on film recyclability.

Further, the disclosed films exhibit favorable optical properties, including improved clarity and decreased haze compared to prior art polyester films.

Although several advantages of the disclosed film are set forth in detail herein, the list is by no means limiting. Particularly, one of ordinary skill in the art would recognize that there can be several advantages to the presently disclosed subject matter that are not included herein.

### EXAMPLES

The following Examples provide illustrative embodiments. In light of the present disclosure and the general level of skill in the art, those of ordinary skill in the art will appreciate that the following Examples are intended to be exemplary only and that numerous changes, modifications, and alterations can be employed without departing from the scope of the presently disclosed subject matter.

Several film structures in accordance with the presently disclosed subject matter and comparatives are identified herein below in Tables 1 and 2.

TABLE 1
Resin Identification

| | Trade Name or | |
|---|---|---|
| Material Code | Designation | Source |
| A | Embrace | Eastman Chemical |
| | | Company (Kingsport, |
| | | Tennessee, United |
| | | States of America) |
| B | Futura PTN Type 2001 | Futura Polyesters, Ltd. |
| | | (Mumbai, India) |
| C | PBS 1903E | Zhejiang Hangzhou Xinfu |
| | | Pharmaceutical Co. |
| | | (Zhejiang, China) |
| D | PBS 1903F | Zhejiang Hangzhou Xinfu |
| | | Pharmaceutical Co. |
| | | (Zhejiang, China) |
| E | PLA 4042D | NatureWorks, LLC |
| | | (Minnetonka, Minnesota, |
| | | United States of America) |
| F | PBS 2003F | Zhejiang Hangzhou Xinfu |
| | | Pharmaceutical Co. |
| | | (Zhejiang, China) |
| G | Biocosafe ™ PBSA | Zhejiang Hangzhou Xinfu |
| | | Pharmaceutical Co. |
| | | (Zhejiang, China) |
| H | Biocosafe ™ 2003 PBAT | Zhejiang Hangzhou Xinfu |
| | | Pharmaceutical Co. |
| | | (Zhejiang, China) |

A is polyethylene terephthalate/glycol (PETG) with density of 1.32 g/cc, inherent viscosity of 0.75+/−0.02, glass transition temperature of 70.6° C., and vicat softening temperature of 68.9° C.

B is a polytrimethylene napthalate thermoplastic polyester resin with density of 0.8+/−0.1 g/cc and melting point 204° C.+/−5° C.

C is polybutylene succinate resin with density of 1.18-1.28 g/cc (20° C.), melting point 110-120° C. (10° C./min), and melt index of 5-10 g/10 min. (150° C., 2.16 kg).

D is polybutylene succinate resin with density of 1.18-1.28 g/cc (20° C.), melting point 110-120° C. (10° C./min), and melt index of g/10 min. (150° C., 2.16 kg).

E is PLA (polylactide) polymer with density of 1.24 g/cc, tensile strength (MD) of 110.1 MPa, tensile strength (TD) 144.5 MPa, elongation at break (MD) of 160% and elongation at break (TD) of 100%.

F is biodegradable polybutylene succinate with density 1.18-1.28 g/cc (20° C.) and melting point of 110-120° C.

G is polybutylene succinate adipate.

H is polybutylene adipate terephthalate with density of 1.19-1.25 g/cc (25° C.), melting point of 110-120° C., and melt index of ≦5.0 g/10 min (190° C., 2.16 kg).

TABLE 2
Film Identification

| Film ID | Layer | Formulation | Volume % | Mils |
|---|---|---|---|---|
| Film 1 | 1 | 100% A | 100 | 10.1 |
| Film 2 | 1 | 99% A | 32.6 | 2.11 |
| | | 1% D | | |
| | 2 | 100% A | 32.6 | 2.11 |
| | 3 | 99% A | 34.8 | 2.25 |
| | | 1% D | | |
| Film 3 | 1 | 97% A | 34.0 | 2.61 |
| | | 3% D | | |
| | 2 | 100% A | 35.6 | 2.73 |
| | 3 | 97% A | 30.4 | 2.33 |
| | | 3% D | | |
| Film 4 | 1 | 100% A | 39.7 | 3.61 |
| | 2 | 100% B | 22.3 | 2.03 |
| | 3 | 100% A | 38.0 | 3.47 |
| Film 5 | 1 | 100% A | 37.4 | 5.43 |
| | 2 | 100% B | 20.3 | 2.94 |
| | 3 | 100% A | 42.3 | 6.09 |
| Film 6 | 1 | 100% C | 100 | 2.0 |
| Film 7 | 1 | 100% D | 100 | 2.0 |
| Film 8 | 1 | 100% E | 100 | 2.0 |
| Film 9 | 1 | 95% E | 100 | 2.0 |
| | | 5% C | | |
| Film 10 | 1 | 90% E | 100 | 2.0 |
| | | 10% C | | |
| Film 11 | 1 | 80% E | 100 | 2.0 |
| | | 20% C | | |
| Film 12 | 1 | 95% E | 100 | 2.0 |
| | | 5% D | | |
| Film 13 | 1 | 90% E | 100 | 2.0 |
| | | 10% D | | |
| Film 14 | 1 | 80% E | 100 | 2.0 |
| | | 20% D | | |
| Film 15 | 1 | 100% A | 100 | 2.0 |
| Film 16 | 1 | 99% A | 100 | 2.0 |
| | | 1% C | | |
| Film 17 | 1 | 95% A | 100 | 2.0 |
| | | 5% C | | |
| Film 18 | 1 | 99% A | 100 | 2.0 |
| | | 1% F | | |
| Film 19 | 1 | 97% A | 100 | 2.0 |
| | | 3% F | | |
| Film 20 | 1 | 95% A | 100 | 2.0 |
| | | 5% F | | |
| Film 21 | 1 | 100% F | 100 | 2.0 |
| Film 22 | 1 | 98% A | 100 | 2.0 |
| | | 2% C | | |
| Film 23 | 1 | 98% A | 100 | 2.0 |
| | | 2% D | | |

### Example 1

### Manufacture of Films 1-23

Films 1-23, with the composition and construction shown in Table 2, were manufactured using a multilayer flat cast film process, as would be known to those of ordinary skill in the art. For shrink films, a round cast process was used, is also well known in the packaging art.

### Example 2

### Impact Strength Testing of Films 1-3

The impact strength of films 1-3 was tested according to ASTM D-3753. The impact strength was tested at 73° F. and 40° F. and the results are given below in Table 3.

The data showed a slight improvement in impact strength for Films 2 and 3 (PET/PBS blends) compared to Film 1 at 73° F., based on energy values. The max load values were not considered due to the thicker gauge (about 10 mil) of the control sample. However, the impact strengths of Films 2 and 3 appeared inferior to Film 1 at 40° F., even though PBS resin has a lower Tg. It should be noted that Films 2 and 3 were made on a single screw extruder (a flat cast film process with a slot die) that does not offer good dispersive mixing.

TABLE 3
Impact Strength of Films 1-3

| | | | Energy | Time to | | | |
|---|---|---|---|---|---|---|---|
| | Test | Max | to Max | Max | Deflection | Total | |
| | Temp. | Load | Load | Load | at Max | Energy | Gauge |
| Film | (° F.) | (lb) | (lb-ft) | (msec) | Load (in) | (lb-ft) | (mil) |
| 1 | 40 | 77 | 1.57 | 3.71 | 0.54 | 1.82 | 10.4 |
| 1 | 73 | 59 | 1.03 | 3.28 | 0.48 | 1.57 | 10.2 |
| 2 | 40 | 42 | 0.52 | 2.73 | 0.40 | 0.81 | 7.0 |
| 2 | 73 | 42 | 0.84 | 3.68 | 0.54 | 1.23 | 7.1 |
| 3 | 40 | 50 | 0.75 | 3.03 | 0.45 | 1.09 | 7.9 |
| 3 | 73 | 45 | 0.87 | 3.59 | 0.53 | 1.29 | 7.9 |

### Example 3

### Oxygen Transmission Rate Testing of Films 1, 4, and 5

The oxygen transmission rate (OTR) of Films 1, 4, and 5 was measured according to ASTM D-3985. The OTR results are shown below in Table 4. As indicated in the data, the OTR values for the films tested reduced with increasing thickness of the polytrimethylene napthalate (PTN) layer.

TABLE 4
Oxygen Transmission Rate of Films 1, 4, 5

| | | | Normalized* | |
|---|---|---|---|---|
| | | | OTR (cc- | Thickness |
| Film | Trial | OTR (cc/m²) | mil/m²) | (mil) |
| 1 | 1 | 22.7 | 233 | 10.2 |
| | 2 | 22.6 | 234 | 10.3 |
| | 3 | 22.3 | 238 | 10.7 |
| 4 | 1 | 13.5 | 116 | 8.6 |
| | 2 | 13.2 | 114 | 8.6 |
| | 3 | 13.6 | 116 | 8.5 |
| 5 | 1 | 8.16 | 120 | 14.8 |
| | 2 | 8.10 | 119 | 14.7 |
| | 3 | 8.16 | 119 | 14.6 |

*Normalized based on total gauge.

### Example 4

### Optical Analysis of Films 1-5

The optical analysis of Films 1-5 was measured according to the method of ASTM D-1003 (clarity was measured in accordance with ASTM D-1746). The results are given below in Table 5. The data indicates that Film 3 (3% PBS blend) showed an increase in haze compared to the other films tested. In addition, Films 4 and 5 (with the PTN blend) had lower haze values when compared to the control (Film 1).

TABLE 5
Haze Testing Results of Films 1-5

| Film | Haze (%) | Gauge (mils) |
|---|---|---|
| 1 | 7.9 | 10.5 |
| 2 | 6.2 | 6.9 |
| 3 | 14.1 | 8.0 |
| 4 | 1.1 | 8.7 |
| 5 | 1.4 | 14.7 |

### Example 5

### Thermal Property Testing of Films 6-17

Differential Scanning calorimetry (DSC) and Thermogravimetric Analyzer (TGA) testing were performed in accordance with ASTM D-3418-2 and ASTM E1131-08 to determine the thermal properties of Films 6-17. The results are given below in Table 6. Films 9-14 (the films containing the PLA/PBS blends) did not show a change in Tg or melt point (i.e., two distinct melt peaks can be seen in the blends). The films containing the PET/PBS blends (Films 16 and 17) exhibited a shift in Tg to a lower temperature (e.g., from 69° C. to 62° C. on blending with 5% PBS). Film 8 (PLA resin) exhibited the lowest degradation temperature (Td) among the films tested.

TABLE 6
DSC and TGA Results for Films 6-17

| | | Tc^{*} | | | | Tc | | |
|---|---|---|---|---|---|---|---|---|
| | | (° C., | | | | (° C., | | |
| | Tg | from | ΔH | Tm | ΔH | from | ΔH | Tc (° C., |
| Film | (° C.) | solid) | (J/g) | (° C.) | (J/g) | melt) | (J/g) | in air) |
| 6 | — | 102 | −4.14 | 112.2 | 51.5 | 79.6 | −60.3 | 408 |
| 7 | — | 98 | −10.3 | 115.8 | 64.4 | 72.0 | −65.0 | 409 |
| 8 | 56.3 | — | — | 151 | — | — | — | 396 |
| 9 | 57.7 | — | — | 112 | — | — | — | — |
| | | | | (PLA) | | | | |
| | | | | 151 | | | | |
| | | | | (PBS) | | | | |
| 10 | 54.6 | — | — | 112 | — | — | — | — |
| | | | | (PLA) | | | | |
| | | | | 150 | | | | |
| | | | | (PBS) | | | | |
| 11 | 54.3 | — | — | 112 | — | — | — | — |
| | | | | (PLA) | | | | |
| | | | | 151 | | | | |
| | | | | (PBS) | | | | |
| 12 | 55.5 | — | — | 112 | — | — | — | — |
| | | | | (PLA) | | | | |
| | | | | 150 | | | | |
| | | | | (PBS) | | | | |
| 13 | 55.5 | — | — | 112 | — | — | — | — |
| | | | | (PLA) | | | | |
| | | | | 150 | | | | |
| | | | | (PBS) | | | | |
| 14 | 55.2 | — | — | 112 | — | | — | — |
| | | | | (PLA) | | | | |
| | | | | 149 | | | | |
| | | | | (PBS) | | | | |
| 15 | 69.5 | — | — | — | — | — | — | 446 |
| 16 | 67.9 | — | — | — | — | — | — | — |
| 17 | 61.9 | — | — | — | — | — | — | — |

^{*}Tc = crystallization temperature

### Example 6

### Tensile Strength Testing of Films 6-17

The tensile properties of Films 6-17 were tested using the methods cited in ASTM D-3759. The results are given below in Table 7. It was observed that Films 6 and 7 (PBS resin) have lower modulus compared to Film 8 (PLA) or Film 15 (PET). The films comprising blends (Films 9-14 and 16-17) showed lower modulus depending on the level of PBS. No further drastic shifts in properties were noted in Films 9-14 and 16-17.

TABLE 7
Tensile Strength Results of Films 6-17

| | | | Ten. | | Ten. | Elong. | |
|---|---|---|---|---|---|---|---|
| | | | Str. at | Elong. | Str. at | at | |
| | | Gauge | Yield | at Yield | Break | Break | Modulus |
| Film | | (mil) | (psi) | (%) | (psi) | (%) | (psi) |
| 6 | MD | 2.3 | 3490 | 6.7 | 6580 | 510 | 98200 |
| | TD | 2.3 | 3060 | 5.7 | 5350 | 430 | 92000 |
| 7 | MD | 2.2 | 3170 | 6.7 | 5480 | 390 | 84000 |
| | TD | 2.5 | 3200 | 7.0 | 5110 | 380 | 80800 |
| 8 | MD | 2.6 | — | — | 9030 | 6.8 | 408000 |
| | TD | 2.2 | — | — | 5900 | 4.1 | 387000 |
| 9 | MD | 2.5 | — | — | 7460 | 4.6 | 390000 |
| | TD | 2.5 | — | — | 4510 | 3.4 | 357000 |
| 10 | MD | 2.5 | — | — | 8060 | 4.7 | 368000 |
| | TD | 2.4 | — | — | 4400 | 3.8 | 356000 |
| 11 | MD | 2.4 | — | — | 8100 | 4.6 | 362000 |
| | TD | 2.2 | — | — | 5350 | 3.1 | 340000 |
| 12 | MD | 2.2 | — | — | 7180 | 4.5 | 403000 |
| | TD | 2.3 | — | — | 5500 | 4.0 | 378000 |
| 13 | MD | 2.3 | — | — | 7500 | 4.6 | 401000 |
| | TD | 2.3 | — | — | 6030 | 3.8 | 387000 |
| 14 | MD | 2.1 | — | — | 8010 | 4.5 | 376000 |
| | TD | 2.2 | — | — | 5260 | 4.4 | 336000 |
| 15 | MD | 2.1 | — | — | 6280 | 4.6 | 254000 |
| | TD | 2.1 | — | — | 5140 | 3.4 | 263000 |
| 16 | MD | 2.4 | — | — | 6420 | 4.6 | 263000 |
| | TD | 2.3 | — | — | 6340 | 4.1 | 260000 |
| 17 | MD | 2.2 | — | — | 5990 | 4.5 | 255000 |
| | TD | 2.3 | — | — | 5700 | 3.8 | 252000 |

### Example 7

### Impact Strength Testing of Films 6-17

The impact strength of Films 6-17 was tested according to ASTM D-3753. The results are given below in Table 8. From the data, it was observed that the impact strength of Film 8 (PLA) did not change or improve by blending with PBS resin (Films 9-14). However, it was noted that the PET/PBS blend films (Films 16 and 17) showed an improvement in peak load values and overall displacement compared to PET alone (Film 15).

TABLE 8
Impact Strength Results for Films 6-17

| | Peak | Break | Energy to | Energy to | Displ. | Gauge |
|---|---|---|---|---|---|---|
| Film | Load (N) | Load (N) | Peak (J) | Break (J) | (mm) | (mil) |
| 6 | 8.1 | 8.2 | 0.0 | 0.0 | 2.5 | 2.4 |
| 7 | 32.6 | 32.6 | 0.2 | 0.2 | 12.4 | 2.7 |
| 8 | 10.2 | 10.1 | 0.0 | 0.0 | 3.8 | 2.3 |
| 9 | 11.1 | 11.1 | 0.0 | 0.0 | 3.6 | 2.3 |
| 10 | 11.2 | 11.2 | 0.0 | 0.0 | 4.0 | 2.2 |
| 11 | 9.8 | 9.8 | 0.0 | 0.0 | 3.6 | 2.7 |
| 12 | 8.5 | 8.5 | 0.0 | 0.0 | 3.3 | 2.4 |
| 13 | 9.4 | 9.4 | 0.0 | 0.0 | 3.5 | 2.3 |
| 14 | 8.9 | 8.9 | 0.0 | 0.0 | 3.3 | 2.3 |
| 15 | 22.6 | 22.6 | 0.1 | 0.1 | 4.8 | 2.2 |
| 16 | 34.4 | 34.4 | 0.1 | 0.1 | 7.4 | 2.5 |
| 17 | 23.2 | 23.2 | 0.1 | 0.1 | 6.2 | 2.2 |

### Example 8

### Moisture Barrier Testing of Films 15-17

The moisture vapor transmission rate (MVTR) at 100° F./100% RH of Films 15-17 was tested in triplicate using the method cited in ASTM F-1249. The results are given below in Table 9. From the data, there was no observed change in the MVTR values by blending 1% to 5% PBS resin (Films 16 and 17) in PET compared to PET alone (Film 15).

TABLE 9
Moisture Vapor Transmission Rate of Films 15-17

| | | | | Normalized |
|---|---|---|---|---|
| | | Thickness | MVTR | MVTR (g- |
| Film | Trial | (mil) | (g/100 in²) | mil/100 in²) |
| 15 | 1 | 2.46 | 1.9 | 4.67 |
| | 2 | 2.41 | 1.9 | 4.58 |
| | 3 | 2.50 | 1.9 | 4.75 |
| 16 | 1 | 1.99 | 2.2 | 4.38 |
| | 2 | 2.13 | 2.1 | 4.47 |
| | 3 | 1.95 | 2.3 | 4.49 |
| 17 | 1 | 2.21 | 2.2 | 4.86 |
| | 2 | 1.89 | 2.5 | 4.73 |
| | 3 | 2.15 | 2.3 | 4.95 |

### Example 9

### Oxygen Transmission Rate Testing of Films 6, 7, 8, and 15

The oxygen transmission rate (OTR) of Films 6, 7, 8, and 15 was tested in triplicate and measured according to ASTM D-3985. The results are given below in Table 10. It is noted that the OTR was evaluated for the individual material, not the blends. Films 6 and 7 (PBS) showed lower OTR compared to Film 8 (PLA). Film 15 (PET) had the lowest OTR values among the 4 films tested.

TABLE 10
OTR Test Results for Films 6, 7, 8, and 15

| | | | | Normalized |
|---|---|---|---|---|
| | | Thickness | OTR (cc/m²- | OTR (cc- |
| Film | Trial | (mil) | day-atm) | mil/m²) |
| 6 | 1 | 2.40 | 212 | 509 |
| | 2 | 2.59 | 199 | 515 |
| | 3 | 2.52 | 204 | 514 |
| 7 | 1 | 2.24 | 221 | 495 |
| | 2 | 2.38 | 208 | 495 |
| | 3 | 2.42 | 201 | 486 |
| 8 | 1 | 2.38 | 315 | 750 |
| | 2 | 2.02 | 326 | 659 |
| | 3 | 2.00 | 344 | 688 |
| 15 | 1 | 2.65 | 91.0 | 241 |
| | 2 | 2.50 | 94.0 | 235 |
| | 3 | 2.56 | 94.0 | 241 |

### Example 10

### Haze Testing of Films 6-17

The optical properties of Films 6-17 was tested according to the method of ASTM D-1003 (clarity was measured in accordance with ASTM D-1746). The results are given below in Table 11. The data indicated that the haze values of the blends (Films 9-14 and 16-17) was higher than Films 6 and 7 (containing PBS), Film 8 (containing PLA) and Film 15 (containing PET). However, it was noted that the effect was minimal when the PBS resin was blended at less than 5% in PET (Film 16).

TABLE 11
Haze Testing Results for Films 6-17

| Film | Haze (%) | Gauge (mil) |
|---|---|---|
| 6 | 70.6 | 2.28 |
| 7 | 32.4 | 2.51 |
| 8 | 5.0 | 2.44 |
| 9 | 11.3 | 2.39 |
| 10 | 19.2 | 2.45 |
| 11 | 33.7 | 2.80 |
| 12 | 12.7 | 2.37 |
| 13 | 4.5 | 2.25 |
| 14 | 6.7 | 2.28 |
| 15 | 5.3 | 2.22 |
| 16 | 2.3 | 2.18 |
| 17 | 12.9 | 2.31 |

### Example 11

### Thermal Property Testing of Films 6, 15, and 18-21

Differential Scanning calorimetry (DSC) and Thermogravimetric Analyzer (TGA) testing were performed in accordance with ASTM D-3418-2 and ASTM E1131-08 to determine the thermal properties of Films 6, 15, and 18-21. The results are given below in Table 12. From the data, it appears that the Tg of PETG has some shift with the presence of PBS resin. The melt point of the PBS resin was not detected in thermograms, even at 5% loading. The pure PBS (Film 21) showed melt point at about 119° C. and exhibited crystallization peak on cooling from melt. Film 6 showed slightly lower melt point.

TABLE 12
Thermal Property Testing Results of Films 6, 15, and 18-20

| | | Tc Heating | | |
|---|---|---|---|---|
| | | from Solid | | |
| Film | Tg (° C.) | State (° C.) | Tm (° C.) | Tc (° C.) |
| 15 | 71.0 | — | — | — |
| 18 | 69.3 | — | — | — |
| 19 | 67.9 | — | — | — |
| 20 | 67.6 | — | — | — |
| 21 | — | — | 119.2 | 65.8 |
| 6 | — | 94.8 | 109.3 | 68.8 |

### Example 12

### Tensile Strength Testing of Films 15, 18, 19, and 20

The tensile properties of Films 15, 18, 19, and 20 were tested using the methods cited in ASTM D-3759. The results are given below in Table 13. A slight decrease in tensile strength values at break was noted upon blending PBS in PETG (Films 18-20).

TABLE 13
Tensile Strength Data for Films 15, 18, 19, and 20

| | | Tensile | Elongation | | |
|---|---|---|---|---|---|
| | | Strength at | at Break | Modulus | Thickness |
| Film | Direction | Break (psi) | (%) | (psi) | (mil) |
| 15 | MD | 7600 | 3.2 | 286,000 | 2.04 |
| | TD | 4350 | 3.7 | 285,000 | 2.15 |
| 18 | MD | 6800 | 3.3 | 291,000 | 2.55 |
| | TD | 6590 | 3.4 | 288,000 | 2.96 |
| 19 | MD | 6860 | 3.4 | 271,000 | 3.22 |
| | TD | 5990 | 3.3 | 282,000 | 2.80 |
| 20 | MD | 6380 | 3.3 | 310,000 | 2.19 |
| | TD | 5870 | 3.5 | 276,000 | 2.25 |

### Example 13

### Impact Strength Testing of Films 15 and 18-20

The impact strength of Films 15 and 18-20 was tested according to ASTM D-3753. The results are given below in Table 14. The data showed an improvement in peak load and energy to break upon blending with PBS (Films 18-20). The values increased by blending as little as 1% PBS (Film 18) to max 3% PBS (Film 19). The normalized values for peak load are also shows to eliminate the effect of thicker gauge for some blend samples.

TABLE 14
Impact Strength Data for Films 15 and 18-20

| | Peak | Normalized | Break | Energy | | | |
|---|---|---|---|---|---|---|---|
| | Load | Peak Load | Load | to Peak | Energy to | Displ. to | Thickness |
| Film | (N) | (N/mil) | (N) | (J) | Break (J) | Break (mm) | (mil) |
| 15 | 34.82 | 15.1 | 34.82 | 0.10 | 0.10 | 5.65 | 2.30 |
| 18 | 56.47 | 19.0 | 56.47 | 0.19 | 0.19 | 7.21 | 2.96 |
| 19 | 72.01 | 23.2 | 72.01 | 0.33 | 0.33 | 9.20 | 3.10 |
| 20 | 40.87 | 17.6 | 40.87 | 0.15 | 0.15 | 7.01 | 2.32 |

### Example 14

### Haze Testing of Films 15 and 18-20

The optical analysis of Films 15 and 18-20 was measured according to the method of ASTM D-1003 (clarity was measured in accordance with ASTM D-1746). The results are given below in Table 15. The data indicated that the haze of Film 15 (PETG) increased upon blending with 3% or more PBS resin (Films 19, 20). However, it should be noted that the haze values are all below 5%.

TABLE 15
Haze Testing Results for Films 15 and 18-20

| Film | Haze (%) | Thickness (mil) |
|---|---|---|
| 15 | 0.6 | 2.31 |
| 18 | 0.8 | 3.00 |
| 19 | 2.3 | 2.96 |
| 20 | 2.7 | 2.37 |

### Example 15

### Thermal Property Testing of Resins C, D, G, and H

Samples of resins PBS (resin C), PBS (resin D), PBSA (G), and PBAT (H) from Table 1 were obtained from Zhejiang Hangzhou Xinfu Pharmaceutical Co. (Zhejiang, China). Differential Scanning calorimetry (DSC) and Thermogravimetric Analyzer (TGA) testing were performed in accordance with ASTM D-3418 and ASTM E1131-08 to determine the thermal properties of the resins. The results are given below in Table 16. From the data, it appears that none of the samples exhibited glass transition temperature as it may be at much lower temperature for these materials. A small peak was noted in all samples just prior to melting. Since the peak was an endothermic peak (−ΔH), it was assumed that the material crystallized to some degree prior to melting. PBSA resin (G) exhibited lower melt point compared to PBS (C, D).

TABLE 16
DSC Test Results for Resins C, D, G, and H

| | Tc (from | | | | | |
|---|---|---|---|---|---|---|
| | solid) | | | | | |
| Resin | (° C.) | ΔH (J/g) | Tm ( C.) | ΔH (J/g) | Tc (° C.) | ΔH (J/g |
| C | 94.8 | −4.75 | 108.5 | 56.1 | 68.2 | −56.2 |
| D | 95.4 | −5.22 | 107.1 | 54.7 | 64.9 | −57.4 |
| G | 69.4 | −3.80 | 90.2 | 44.5 | 32.2 | −47.4 |
| H | — | — | 110.3* | — | 55.4 | −18.4 |

^{*}Did not show good baseline to measure ΔH.

### Example 16

### Tensile Strength Testing of Films 24 and 25

A monolayer film sample of 100% PBSA (resin G) (herein referred to as Film 24) was obtained from Zhejiang Hangzhou Xinfu Pharmaceutical Co. A monolayer film sample of 100% PBAT (resin H) (herein referred to as Film 25) was also obtained Zhejiang Hangzhou Xinfu Pharmaceutical Co. The tensile properties of Films 24 and 25 were tested using the methods cited in ASTM D-3759. The results are given below in Table 17. Film 24 (PBSA) did not show a clear yield point and did not exhibit similar properties in MD and TD, likely due to the process conditions used during film manufacturing. Film 24 also exhibited very long elongation to break in TD.

TABLE 17
Tensile Strength Results for Films 24 and 25

| | | | | Ten. | | Ten. | Elong. |
|---|---|---|---|---|---|---|---|
| | | | | Str. at | Elong. | Str. at | at |
| | Test | | Gauge | Yield | at Yield | Break | Break |
| Film | Direction | | (mil) | (lbf) | (%) | (lbf) | (%) |
| 24 | MD | Avg. | 0.63 | — | — | 7480 | 210 |
| | TD | Std. | 0.04 | — | — | 169 | 9 |
| | | Dev. | | | | | |
| 24 | MD | Avg. | 0.56 | — | — | 3650 | 3.3 |
| | TD | Std. | 0.02 | — | — | 321 | 0.48 |
| | | Dev. | | | | | |
| 25 | MD | Avg. | 1.01 | — | — | 3430 | 580 |
| | TD | Std. | 0.01 | — | — | 93.8 | 15 |
| | | Dev. | | | | | |
| 25 | MD | Avg. | 1.02 | 1200 | 22 | 3560 | 580 |
| | TD | Std. | 0.0 | 19.2 | 2.1 | 121 | 29 |
| | | Dev. | | | | | |

### Example 17

### Oxygen Transmission Rate Testing of Films 24 and 25

The oxygen transmission rate (OTR) of Films 24 and 25 was tested in triplicate and measured at 73° F. and 0% relative humidity according to ASTM D-3985. The results are given below in Table 18. It was noted that the oxygen transmission rate of the samples were high. Based on the normalized values, Film 24 (PBSA) showed slightly higher OTR when compared to Film 25 (PBAT).

TABLE 18
OTR Results for Films 24 and 25

| | | | Normalized | |
|---|---|---|---|---|
| | | | OTR (cc- | |
| Film | Sample No. | OTR (cc/m²) | mil/m²) | Gauge (mil) |
| 24 | 1 | 4030 | 2740 | 0.68 |
| | 2 | 4540 | 3359 | 0.74 |
| | 3 | 4900 | 3332 | 0.68 |
| 25 | 1 | 2360 | 2218 | 0.94 |
| | 2 | 2900 | 2842 | 0.98 |
| | 3 | 3660 | 3367 | 0.92 |

### Example 18

### Impact Strength Testing of Films 15, 22, and 23

Monolayer films 15 (control), 22 (2% PBS), and 23 (2% PBS) were prepared and oriented to create shrink sleeve samples. The films were oriented in the machine direction by running the films over a series of steel rollers, as would be known in the art. The series of rollers included preheated rollers that were used to heat the film to an orientation temperature of 220° F. with a soak time of 20 seconds. The samples were stretched at a draw ratio of 3.0×1.05, a draw rate of 5.0 in/sec., a quench air start at 94%, and a quench air stop at 99%. The impact strength of each film sample was tested in duplicate in accordance with ASTM D-3753-09. Table 19 illustrates the percent free shrink in the transverse direction (TD) and machine direction (MD) at various temperatures.

TABLE 19
Impact Strength of Films 15, 22, and 23

| | Film 15 | | Film 22 | | Film 23 | |
|---|---|---|---|---|---|---|
| Temperature (° F) | TD | MD | TD | MD | TD | MD |
| 158 | 0 | 10 | 0 | 7 | 0 | 7 |
| 158 | 0 | 5 | −1 | 6 | −1 | 8 |
| 176 | 0 | 31 | −1 | 25 | 0 | 0 |
| 176 | 0 | 29 | 0 | 26 | 0 | 0 |
| 190 | 0 | 41 | 0 | 42 | 0 | 42 |
| 190 | −1 | 45 | −1 | 42 | −1 | 42 |

What is claimed is:

1. A polymeric film, said film comprising at least one layer comprising a blend of:
a. a first component comprising about 90 to 99% polyester, based on the total weight of the layer; and
b. a second component comprising about 1 to 10% biodegradable aliphatic or aromatic polyester, based on the total weight of the layer,
wherein the film has a free shrink at 185° F. in at least one of the machine or transverse directions of at least about 10% measured in accordance with ASTM D 2732.

2. The film of claim 1, wherein said blend is present in the skin layer of said film.

3. The film of claim 1, wherein said biodegradable aliphatic or aromatic polyester is selected from the group consisting of polybutylene succinate, polybutylene succinate adipate, polybutylene adipate terephthalate, polyhydroxyalkanoate, and copolymers thereof.

4. The film of claim 1, wherein said film has a flexural modulus of elasticity at room temperature of less than 2 GPa.

5. The film of claim 1, wherein said film has an instrumented impact strength with an average energy to break of at least 2 Joules, in accordance with ASTM D-3753.

6. The film of claim 1, wherein said film has a free shrink at 185° F. in at least one of the machine or transverse directions of at least about 40% measured in accordance with ASTM D 2732.

7. A shrink sleeve comprising the film of claim 1.

8. A packaged object comprising:
a. a container comprising the film of claim 1 and defining an interior space; and
b. an object enclosed in the interior space of the container,
wherein said film has been shrunk to said container.

9. The packaged object of claim 8, wherein the object comprises a food product.

10. A method of labeling a container, said method comprising:
a. obtaining a film comprising at least one layer comprising a blend of:
i. a first component comprising about 90 to 99% polyester, based on the total weight of the layer; and
ii. a second component comprising about 1 to 10% biodegradable aliphatic or aromatic polyester, based on the total weight of the layer,
b. forming said film into a shrink sleeve;
c. positioning said shrink sleeve around said container; and
d. shrinking said shrink sleeve to the container.

11. The method of claim 10, wherein the film has a free shrink at 185° F. in at least one of the machine or transverse directions of at least about 10% measured according to ASTM D 2732.

12. The method of claim 10, wherein said biodegradable aliphatic or aromatic polyester is selected from the group consisting of polybutylene succinate, polybutylene succinate adipate, polybutylene adipate terephthalate, polyhydroxyalkanoate, and copolymers thereof.

13. A method of making a package, said method comprising:
a. obtaining a film comprising at least one layer comprising a blend of:
i. a first component comprising about 90 to 99% polyester, based on the total weight of the layer; and
ii. a second component comprising about 1 to 10% biodegradable aliphatic or aromatic polyester, based on the total weight of the layer,
b. obtaining a container;
c. forming said film into a shrink sleeve;
d. positioning said shrink sleeve around said container; and
e. shrinking said shrink sleeve to the container.

14. The method of claim 13, wherein the film has a free shrink at 185° F. in at least one of the machine or transverse directions of at least about 10% measured according to ASTM D 2732.

15. The method of claim 13, wherein said biodegradable aliphatic or aromatic polyester is selected from the group consisting of polybutylene succinate, polybutylene succinate adipate, polybutylene adipate terephthalate, polyhydroxyalkanoate, and copolymers thereof.
